(19) United States
(12) Patent Application Publication
(10) Pub. No.: US 2026/0058685 A1
(43) Pub. Date: Feb. 26, 2026

(54) RADIO-FREQUENCY FRONT-END ARCHITECTURE

(71) Applicant: Skyworks Solutions, Inc., Irvine, CA (US)

(72) Inventor: David Richard Pehlke, Westlake Village, CA (US)

(21) Appl. No.: 19/306,804

(22) Filed: Aug. 21, 2025

Related U.S. Application Data
(60) Provisional application No. 63/686,080, filed on Aug. 22, 2024.

(51) Int. Cl. H04B 1/401; H04B 1/00

(52) U.S. Cl. CPC H04B 1/401; H04B 1/0064

(57) ABSTRACT

A radio frequency front end is configurable in a time-staggered diversity receive mode to control an antenna switch to connect a different one of a plurality of antennas to a receive path in each of a series of sequential time slots that do not overlap in time, such that the transmit/receive component redundantly receives the same data in each of the series of sequential time slots using a different one of the plurality of antennas.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### FIELD

The present disclosure relates to a radio frequency (RF) front-end architecture for transmitting and receiving RF signals. The disclosure further relates to a RF module and a wireless communication device.

### TECHNICAL BACKGROUND

In modern wireless RF communication systems, there is a general trend toward achieving higher data rate, improved reliability, and enhanced capacity to support the growing demand for mobile data. Therefore, it is becoming increasingly apparent that numerous modern RF wireless communication systems utilize ingeniously designed RF front-end architectures.

The design of the front-end modules from earlier generation communication technologies undergoes challenges in the transition to the modern communication technologies. These challenges include improving power efficiency for millimeter wave radios, increasing the number of antennas necessary to reach the coexistence of different radios, to achieve wider channel bandwidth up to hundreds of MHz, and so on.

An important improvement in front-end architectures for achieving this tendency is the significant use of multiple antenna reception and transmission in RF front-end architecture to enable different multi-input multi-output (MIMO) operating modes with more than one layer. The MIMO system presents several operating modes, such as transmit diversity, receive diversity, spatial diversity, spatial multiplexing, cyclic delay diversity, beamforming and the like.

Those technical modes of MIMO systems mentioned above primarily support multiple parallel transmission and reception of RF signals. To enable the MIMO systems to operate concurrently to transmit or receive RF signals, the prior RF front-end architecture typically needs to activate all antennas at a time so that they can operate in parallel. In this case, the prior RF front-end architecture typically includes multiple transmit/receive components and multiple antennaplexers with each of them comprising a pair of transmit/receive component-antennaplexer coupled to a single antenna. These pairs are combined to create a complete RF front-end architecture that operates in various modes.

The pair of transmit/receive component-antennaplexer coupled to a single antenna inevitably leads to some duplication of hardware and functions along certain transmission or reception paths with the increasing numbers of antennas.

Therefore, the favorable trend toward achieving higher data rate, improved reliability, and enhanced capacity in RF front-end architecture poses a challenge for the reduction of hardware cost without compromising their signal-to-noise ratio (SNR) and achievable gain, which are three of the most important factors in measuring the performance of an RF front-end.

### SUMMARY

In some aspects, the techniques described herein relate to a radio frequency front-end system, including: a plurality of antennas; a transmit/receive component including a transmit path for transmitting radio frequency signals, a receive path for receiving radio frequency signals; an antenna switch arranged between the plurality of antennas and the transmit/receive component; and a control device configurable in a time-staggered diversity receive mode to control the antenna switch to connect a different one of the plurality of antennas to the receive path in each of a series of sequential time slots that do not overlap in time, such that the transmit/receive component receives a copy of the same data in each of the series of sequential time slots using a different one of the plurality of antennas.

In some aspects, the techniques described herein relate to a radio frequency front-end system wherein control device is further configurable in a time-staggered diversity transmit mode to control the antenna switch to connect a different one of the plurality of antennas to the transmit path in each of a series of sequential time slots that do not overlap in time, such that the transmit/receive component transmits a copy of the same data in each of the series of sequential time slots using a different one of the plurality of antennas.

In some aspects, the techniques described herein relate to a radio frequency front-end system wherein the transmit/receive component includes a switch, and the control device is configurable in the time-staggered diversity receive mode to control the switch to connect the receive path to the antenna switch.

In some aspects, the techniques described herein relate to a radio frequency front-end system wherein the control device is configurable in the time-staggered diversity transmit mode to control the switch to connect the transmit path to the antenna switch.

In some aspects, the techniques described herein relate to a radio frequency front-end system wherein the transmit/receive component further includes a second receive path connected directly to the antenna switch.

In some aspects, the techniques described herein relate to a radio frequency front-end system wherein the transmit path in the transmit/receive component includes at least one first filter.

In some aspects, the techniques described herein relate to a radio frequency front-end system wherein the transmit path includes a power amplifier and the receive path includes a low noise amplifier, the switch arranged between the power amplifier and the antenna switch and the switch arranged between the low noise amplifier and the antenna switch.

In some aspects, the techniques described herein relate to a radio frequency front-end system wherein the plurality of antennas are included in at least one antenna array.

In some aspects, the techniques described herein relate to a radio frequency front-end system wherein the antenna array is a MIMO antenna system supporting at least one of a downlink MIMO function and an uplink MIMO function.

In some aspects, the techniques described herein relate to a radio frequency front-end system wherein the radio frequency front-end system is configured to operate with a WiFi network protocol.

In some aspects, the techniques described herein relate to a radio frequency front-end system wherein the radio frequency front-end system is configured to operate with at least one global navigation satellite system (GNSS).

In some aspects, the techniques described herein relate to a radio frequency front-end system wherein the radio frequency front-end system is configured to operate with the Bluetooth technology standard.

In some aspects, the techniques described herein relate to a radio frequency module, including: a printed circuit board; a radio frequency front-end system arranged on the printed circuit board and including a plurality of antennas; a transmit/receive component including a transmit path for transmitting radio frequency signals, a receive path for receiving radio frequency signals; an antenna switch arranged between the plurality of antennas and the transmit/receive component; and a control device configurable in a time-staggered diversity receive mode to control the antenna switch to connect a different one of the plurality of antennas to the receive path in each of a series of sequential time slots that do not overlap in time, such that the transmit/receive component receives a copy of the same data in each of the series of sequential time slots using a different one of the plurality of antennas.

In some aspects, the techniques described herein relate to. The radio frequency module wherein control device is further configurable in a time-staggered diversity transmit mode to control the antenna switch to connect a different one of the plurality of antennas to the transmit path in each of a series of sequential time slots that do not overlap in time, such that the transmit/receive component transmits a copy of the same data in each of the series of sequential time slots using a different one of the plurality of antennas.

In some aspects, the techniques described herein relate to a radio frequency module wherein the transmit/receive component includes a switch, and the control device is configurable in the time-staggered diversity receive mode to control the switch to connect the receive path to the antenna switch.

In some aspects, the techniques described herein relate to a radio frequency module wherein the control device is configurable in the time-staggered diversity transmit mode to control the switch to connect the transmit path to the antenna switch.

In some aspects, the techniques described herein relate to a radio frequency module wherein the transmit/receive component further includes a second receive path connected directly to the antenna switch.

In some aspects, the techniques described herein relate to a wireless communication device, including: a housing; at least one processing component arranged in the housing and configured to process information within the wireless communication device; and a radio frequency module arranged in the housing, the radio frequency module including a printed circuit board and a radio frequency front-end arranged on the printed circuit board, the radio frequency front-end including a plurality of antennas; a transmit/receive component including a transmit path for transmitting radio frequency signals, a receive path for receiving radio frequency signals; an antenna switch arranged between the plurality of antennas and the transmit/receive component; and a control device configurable in a time-staggered diversity receive mode to control the antenna switch to connect a different one of the plurality of antennas to the receive path in each of a series of sequential time slots that do not overlap in time, such that the transmit/receive component receives a copy of the same data in each of the series of sequential time slots using a different one of the plurality of antennas.

In some aspects, the techniques described herein relate to a wireless communication device wherein control device is further configurable in a time-staggered diversity transmit mode to control the antenna switch to connect a different one of the plurality of antennas to the transmit path in each of a series of sequential time slots that do not overlap in time, such that the transmit/receive component transmits a copy of the same data in each of the series of sequential time slots using a different one of the plurality of antennas.

In some aspects, the techniques described herein relate to a wireless communication device wherein the transmit/receive component includes a switch, and the control device is configurable in the time-staggered diversity receive mode to control the switch to connect the receive path to the antenna switch.

According to a first aspect, the present disclosure provides a radio frequency (RF) front-end (RFFE) architecture. The RFFE architecture comprises: an antenna component including a plurality of antennas; a transmit/receive component including at least one transmit path for transmitting RF signals, at least one receive path for receiving RF signals and a controllable first RF switch module; a controllable second RF switch module arranged between the antenna component and the transmit/receive component; a control device for controlling the controllable first and second RF switch modules. The controllable first RF switch module is arranged between a transmit path and a receive path and controlled by the control device such to switch between the transmit path and the receive path, and wherein the controllable second RF switch module is controlled by the control device such to switch to one of the antennas of the plurality of antennas and to switch between a transmit mode and a receive mode, so that the controllable second RF switch module is configured to activate one of the antennas of the plurality of antennas at a time and one after another.

According to a second aspect, the present disclosure provides a RF module. The RF module comprises a printed circuit board (PCB), and an RF front-end (RFFE) architecture arranged to the PCB. The RFFE architecture includes an antenna component including a plurality of antennas, a transmit/receive component including at least one transmit path for transmitting RF signals, at least one receive path for receiving RF signals and a controllable first RF switch module, a controllable second RF switch module arranged between the antenna component and the transmit/receive component, and a control device for controlling the controllable first and second RF switch modules. The controllable first RF switch module is arranged between the transmit path and the receive path and controlled by the control device such to switch between the transmit path and the receive path. The controllable second RF switch module is controlled by the control device such to switch to one of the antennas of the plurality of antennas and to switch between a transmit mode and a receive mode, so that the controllable second RF switch module is configured to activate one of the antennas of the plurality of antennas at a time and one after another.

According to a third aspect, the present disclosure provides a wireless communication device. The wireless communication device includes a housing, and at least one processing component arranged to the housing. At least one of the processing components is configured to process the information within the wireless communication device. The wireless communication device further includes a radio frequency (RF) module arranged to the housing, the RF module including a printed circuit board (PCB), and an RF front-end (RFFE) architecture arranged on the PCB. The RFFE architecture includes an antenna component including a plurality of antennas, a transmit/receive component including at least one transmit path for transmitting RF signals, at least one receive path for receiving RF signals and a controllable first RF switch module, a controllable second RF switch module arranged between the antenna component and the transmit/receive component, and a control device for controlling the controllable first and second RF switch modules. The controllable first RF switch module is arranged between the transmit path and the receive path and controlled by the control device such to switch between the transmit path and the receive path. The controllable second RF switch module is controlled by the control device such to switch to one of the antennas of the plurality of antennas and to switch between a transmit mode and a receive mode, so that the controllable second RF switch module is configured to activate one of the antennas of the plurality of antennas at a time and one after another.

This disclosure is based on the idea to provide an RF front-end architecture, which realizes the elimination of the duplication of hardware without compromising their spectral efficiency (SNR) and achievable gain.

As outlined in the proposed RFFE architecture, the RFFE architecture includes a transmit/receive component including at least one transmit path for transmitting RF signals, at least one receive path for receiving RF signals and a controllable first RF switch module arranged between the transmit path and the receive path. The RFFE architecture further comprises a antenna component including a plurality of antennas and a controllable second RF switch module arranged between the antenna component and the transmit/receive component. The controllable first and second RF switch module are controlled by a control device. The controllable first RF switch is configured to switch between the transmit path and the receive path. The controllable second RF switch module is configured to activate one of the antennas of the plurality of antennas at a time and one after another and to switch between a transmit mode and a receive mode.

The transmit/receive component can be, but is not limited to, a broadband transmit/receive component, a broadband receive component, a mid-to-high band (MHB) duplexing component, and/or an ultra-high-band (UHB) duplexing component.

When the proposed RFFE architecture is selected to operated in the transmit mode, the controllable second RF switch module is configured to switch the RF front-end architecture to the transmit mode and active one of the antennas of the plurality of antennas at a time which is ready to transmit RF signals. The controllable first RF switch module is configured to switch to a transmit path.

When the proposed RFFE architecture is selected to operated in the receive mode, the controllable second RF switch module is configured to switch the RF front-end architecture to the receive mode and active one of the antennas of the plurality of antennas at a time which is ready to receive RF signals. The controllable first RF switch module is configured to switch to the receive path.

The proposed RFFE architecture no longer needs to employ antennaplexers or alternative components integrated with the function of an antennaplexer. The proposed RFFE architecture therefore takes advantage of lower insertion loss and enhanced power efficiency. The RFFE architecture can support a time-division-duplex (TDD) scheme. TDD schemes separate transmitted and received RF signals by the allocation of different time slots in the same frequency band. In other words, for the communication device operating in TDD scheme, it can only transmit at one time and only receive at another time. TDD schemes are more preferable when the traffic patterns between the downlink channels and the uplink channels are asymmetric traffic patterns, such that the cost of the RFFE architecture is reduced and it requires less quantity of spectrum. Without the need for frequency separation, the RFFE architecture is designed without antennaplexers. This can lead to an easier adaptation for dynamic switching between transmit and receive modes.

Without antennaplexer or alternative components integrated with the function of antennaplexer, the RFFE architecture can also support a half frequency-division-duplex (FDD) scheme when it incorporates alternative components such as dual-band filters, dual-band amplifiers, dual-band antennas with filtering performance or the like. Half FDD schemes are similar to conventional FDD schemes separating the transmit and receive paths on different frequencies. However, unlike FDD schemes allowing simultaneous bidirectional communication, half FDD schemes have the limitation of not allowing bidirectional communication in the same timeslot.

For the reason that the alternative components can operate with more than one frequency bands, these components can effectively separate the transmit and receive paths, thereby fulfilling the function of an antennaplexer without employing such an antennaplexer. This allows the RF front-end architecture to handle bidirectional communication in different frequency bands.

In order to eliminate the duplication of hardware without compromising their spectral efficiency (SNR) and achievable gain, a single transmit/receive component is coupled to the antenna component with the plurality of antennas and a controllable second RF switch module controlled by a control device is arranged between the antenna component and the transmit/receive component, the controllable second RF switch module actives one of the antennas of the plurality of antennas at a time and one after another. The transmission or the reception result is then aggregated over multiple transmission/reception time periods. This allows range extension and even potentially higher modulation coding scheme (MCS) index or higher order modulation.

Different MIMO operation modes, such as transmit diversity, receive diversity, uplink MIMO, downlink MIMO and the like, is still achieved with the use of proposed RFFE architecture, so that the high SNR and the achievable gain of the proposed RFFE architecture are stilled realized. Furthermore, the hardware cost is also reduced by eliminating the antennaplexer and duplication of the hardware in the RFFE architecture.

Advantageous configurations and developments emerge from the further dependent claims and from the description with reference to the figures of the drawings.

In a possible configuration of the RFFE architecture, the receive path arranged in the transmit/receive component is coupled directly to the controllable second RF switch without arranging with the controllable first RF switch module. This means that a transmit/receive component may comprise multiple receive paths operating with different frequency bands.

When the proposed RFFE architecture is selected to operate in the receive mode, the controllable second RF switch module is configured to switch the RF front-end architecture to the receive mode and active one of the antennas of the plurality of antennas at a time which is ready to receive RF signals. In a possible configuration, another receive path arranged in the transmit/received component is selected directly with the selection of the receive mode of the controllable second RF switch module. In this case, the controllable first RF switch module can be inactive, which means that the controllable first RF switch module neither be switched to the transmit path nor the receive path or the controllable first RF switch module can be switched to the transmit path, but the transmitting function of the RF front-end architecture is not activated.

In a possible configuration of the RFFE architecture, the transmit path in the transmit/receive component comprises at least one first amplifier. The first amplifier may be a power amplifier configured to amplify RF signals with low power through the transmit path. Typically, power amplifiers can be used with their output to drive the antenna in the transmit mode. Power amplifiers ensure that the signal is boosted to a level suitable for efficient and reliable signals over long distances. Design goals of the power amplifier often include gain, power output, bandwidth, power efficiency, linearity, input and output impedance matching, and heat dissipation.

In a possible configuration of the RFFE architecture, the transmit path in the transmit/receive component comprises at least one first filter. The first filter may be a transmit filter configured to filter RF signals through the transmit path. The transmit filter processes the RF signal before its transmission. During transmit signal processing, a series of operations, such as signal mixing, spectrum shaping and the like, are introduced. In this process, the entire transmission signal will introduce various unwanted harmonics or noise, increasing the adjacent channel interference and impairing the SNR. In addition, in systems where the same antenna is used for both transmission and reception, for example, in TDD systems, filtering is crucial to protect the sensitive receiver components from being overloaded or damaged by strong out-of-band signals from the transmit path. A transmit filter can be a low-pass filter, band-pass filter, high-pass filter, band-stop filter or the like and the transmit filter may adopt different filter technologies, such as lumped-element LC filters technology, planar filters technology, coaxial filters technology, cavity filters technology, dielectric filters technology, electroacoustic filters or the like. Transmit filters may be tunable, in order to adapt to filter the RF signals in different frequency bands. Transmit filters facilitate the control of the bandwidth of the transmit RF signal, the reduction of interference with adjacent channels, and the protection of receiver components in shared antenna systems.

In a possible configuration of the RFFE architecture, the receive path in the transmit/receive component comprises at least one second amplifier. The second amplifier may be a low-noise amplifier configured to amplify RF signals with low-power without significantly degrading its signal-to-noise ratio (SNR) through the receive path. The receive RF signals from antennas are usually weak signals due to the propagation losses over distance, obstructions, atmospheric absorption, antenna characteristics, interference, and power limitations of the transmitter. As a result, most of the RF receive signals are just above the noise floor. Any electronic amplifier will amplify the power of both the signal and the noise present at its input. Additionally, the amplifier will also introduce some additional noise by itself. Low-noise amplifiers (LNA) are designed to supply a power gain of the receive RF signals and to minimize this additional noise at the same time. Design goals for the low-noise amplifiers often include gain, noise figure, linearity and maximum RF input.

In a possible configuration of the RFFE architecture, the receive path in the transmit/receive component includes at least one second filter. The second filter may be a receive filter configured to filter RF signals through the receive path. The receive filter process the incoming RF signal before it is further amplified and demodulated. The receive RF signals from antennas are usually weak signals encoded information on RF carriers. Due to the propagation interference over distance, the receive RF signals may superimpose unwanted random signals on the desired signal, which is impairing its SNR. In addition, filtering is crucial to protect the sensitive receiver components from being overloaded or damaged by strong out-of-band signals from the receive path. A receive filter can be a low-pass filter, band-pass filter, high-pass filter, band-stop filter or the like and the receive filter may adopt different filter technologies, such as lumped-element LC filters technology, planar filters technology, coaxial filters technology, cavity filters technology, dielectric filters technology, electroacoustic filters or the like. Receive filters may be tunable, in order to adapt to filter to RF signals in different frequency bands. Receive filters facilitate the selecting and isolating of the desired frequency bands, rejecting out-of-band and adjacent channel interference, and protecting sensitive components from overload.

In a possible configuration of the RFFE architecture, the antenna component includes at least one antenna array. The antenna array may be composed from either at least one one-dimensional, two-dimensional or three-dimensional array that contains a number of antenna components, which are connected or interconnected with each other. The antenna gain is increasing with the addition of other antenna components. For example, the implementation of a MIMO system may be a 2×2 MIMO system, which means it comprises an array of 2×2 antenna components. The implemented architecture can be easily scaled to 4×4 system, which means it comprises an array of 4×4 antenna components. The 4×4 system may also be composed of four 2×2 MIMO systems. The 1×8 antenna component array can be integrated along the edge of a wireless communication device, enabling beamforming at various angles to deliver usable beams along the edges of devices. Three-dimensional antenna component arrays, such as a 4×2×4 configuration or a 4×4×4 antenna configuration, exhibit improved performances when employing joint beamforming techniques. This technique enables the simultaneous achievement of array gain and spatial diversity or multiplexing gain. While traditional beamforming typically requires simultaneous antenna operation, some advanced forms of beamforming can work with phased operation, for instance, with integration of phased array systems, which use a sequential phase-shifting technique to steer beams.

In a possible configuration of the RFFE architecture, the antenna array is a MIMO antenna system supporting at least one of downlink MIMO function and at least of uplink MIMO function. In the uplink MIMO mode of MIMO antenna system, the antenna component in transmit mode will send different signals by each antenna. Exploiting the fact that each signal from each antenna will go through a different path to be transmitted at the base stations with series sequence, it is possible to reconstruct the transmit signal with a certain of mathematic techniques applied to aggregate the transmit series sequences into a whole result of the transmit RF signal. Since there are many signals being transmitted in series time slots, it becomes possible to obtain higher data rates.

In the downlink MIMO mode of MIMO antenna system, the antenna component in receive mode will receive different signals by each antenna. Exploiting the fact that each signal from each antenna will go through a different path from the transmitter at the base stations with series sequence, it is possible to reconstruct the signal on the receiver of user equipment (UE) using mathematic algorithms applied to aggregate the receive series sequences into a whole result of the receive RF signal. Since there are many signals being received in series time slots, it becomes possible to obtain higher data rates.

In a possible configuration of the RFFE architecture, the MIMO antenna system is configured to be operable in at least one transmit diversity mode and in at least one receive diversity mode. In the transmit diversity mode of the MIMO antenna system, the transmitter will send copies of the same RF signals by each antenna, which will result in introduction of redundancy on the communication system. It is possible to reconstruct the transmit signal with a certain mathematic technique applied to aggregate the transmit series sequences into a whole result of the transmit RF signal. This redundancy makes it possible to reduce fading during the signal transmission and also to achieve a better SNR. In the receive diversity mode of the MIMO system, the receiver will receive copies of the same RF signals by each antenna, which will result in the introduction of redundancy on the communication system. It is possible to reconstruct the receive signal with a certain mathematic technique applied to aggregate the receive series sequences into a whole result of the receive RF signal. This redundancy makes it possible to reduce fading and also have a better SNR at the receiver at the user equipment (UE) side.

In a possible configuration of the RF front-end architecture, the RF front-end architecture is configured to operate with at least one of the following technology standards: Global System for Mobile Communications (GSM); Universal Mobile Telecommunications System, (UMTS); Long-term Evolution (LTE); and fifth-generation technology standard (5G). Other standards, however, are also possible. The continuous need for high data rate in wireless communication devices for more users is driving the adoption of new telecommunication technology. At the same time, users are also expecting that the wireless communication devices integrated with advanced telecommunication technologies should also be compatible with previous technologies. The GSM is a standard developed to describe the protocols for second-generation (2G) digital cellular networks used by wireless communication devices such as mobile phones, tablets and the like. The UMTS is a third generation (3G) mobile cellular system for networks based on the GSM standard. UMTS uses wideband code-division multiple access, W-CDMA, technology to offer greater spectral efficiency and bandwidth to mobile network operators. LTE is a standard for wireless broadband communication for fourth generation (4G) wireless communication devices and data terminals, based on the GSM and UMTS standards. It improves on those standards' capacity and speed by using a different radio interface and core network improvements. 5G is the successor to 4G technology that provides connectivity to most current mobile phones. 5G has higher bandwidth to deliver faster speeds than 4G and can thus connect more devices, improving the quality of internet services in crowded areas.

In a possible configuration of the RF front-end architecture, the RF front-end architecture is configured to operate with a Wi-Fi network protocol. Wi-Fi is a family of wireless network protocols based on the IEEE 802.11 family of standards, which are commonly used for local area networking of devices and Internet access, allowing nearby digital devices to exchange data by radio waves. The 802.11 standard provides several distinct radio frequency ranges for use in Wi-Fi communications: 900 MHz, 2.4 GHz, 3.6 GHz, 4.9 GHZ, 5 GHZ, 5.9 GHz, and 60 GHz bands. Each range is divided into a multitude of channels.

In a possible configuration of the RFFE architecture, the front-end architecture is configured to operate with at least one global navigation satellite systems (GNSS). The GNSS device is operable based on the commonly known global positioning system (GPS). However, it is also possible that the GNSS device is operating based on other positioning standards, such as GLONASS, Galileo and/or BeiDou navigation satellite system.

In a possible configuration of the RFFE architecture, the front-end architecture is configured to operate with the Bluetooth® technology standard. Bluetooth® is a short-range wireless technology standard that is used for exchanging data between fixed and mobile devices over short distances and building personal area networks. In the most widely used mode, transmission power is limited, giving it a very short range of limited meters. It employs radio waves ranging from 2.402 GHz to 2.48 GHz. It is mainly used as an alternative to wired connections to exchange files between nearby portable devices.

In a possible configuration of the RF module, the RFFE architecture is mounted or arranged on the PCB or is coupled with the PCB. As outlined in the proposed RFFE architecture, the RFFE architecture comprises a transmit/receive component including at least one transmit path for transmitting RF signals, at least one receive path for receiving RF signals and a controllable first RF switch module arranged between the transmit path and the receive path. The RFFE architecture further comprises a antenna component including a plurality of antennas and a controllable second RF switch module arranged between the antenna component and the transmit/receive component. The controllable first RF switch module and the second RF switch module are controlled by a control device. The controllable first RF switch is configured to switch between the transmit path and the receive path. The controllable second RF switch module is configured to activate one antenna of a plurality of antennas at a time and one after another and switch between a transmit mode and a receive mode.

The transmit/receive component in the time slot of the proposed RFFE architecture can be, but is not limited to, a broadband transmit/receive component, a broadband receive component, a mid-to-high band (MHB) duplexing component, and a ultra-high-band (UHB) duplexing component.

In a possible configuration of the RF module, the RF module further includes an analog-to-digital converter (ADC) arranged on the PCB and coupled to the RFFE architecture. The ADC is configured to convert receive analog signals into receive data streams. An ADC operates at a high sampling rate and converts signals directly from analog RF to digital. In the receive mode of the RF module, the RF signal is first downconverted to an intermediate frequency (IF) or directly to baseband. An ADC is then used to convert the analog IF or baseband signal into a digital signal for further processing. After the analog RF signal is converted to a digital signal, digital signal processing (DSP) techniques are used to demodulate the signal and to extract the transmitted information.

In a possible configuration of the RF module, the RF module further comprises a digital-to-analog converter (DAC) arranged or mounted on the PCB and coupled to the RF front-end architecture. The DAC is configured to convert transmit data streams into transmit analog signals. In the transmit mode of the RF module, DACs convert digital signal processing outputs to analog signals before amplification and transmission. In a further possible configuration, DACs are used to produce analog control signals for various purposes such as gain control, filter tuning, system verification, testing, or calibration purposes or phase adjustment in the analog domain.

In a possible configuration of the RF module, the RF module further includes a modulator arranged on the PCB and coupled to the RFFE architecture. The modulator is configured to convert transmission analog signals into a format suitable for RF signals transmission.

In a possible configuration of the RF module, the RF module further includes a demodulator, arranged on the PCB and coupled to the RFFE architecture. The demodulator is configured to extract the receive analog signals from the received RF signals. A modulator-demodulator or modem is a computer hardware device that is configured to convert data from a digital or analog format into a format suitable for digital processing or an analog transmission medium. A modem that is configured to transmit data by modulating one or more carrier wave signals to encode digital information, while the receiver demodulates the signal to recreate the original digital information. The goal is to produce a signal that can be transmitted easily and decoded reliably.

In a possible configuration of the wireless communication device, the wireless communication device may comprise at least one central processing unit (CPU), a memory, a battery, a power management unit, a motherboard and/or at least one user interface attached to or at least partially embedded in the housing of the wireless communication device. The user interface is the space where interactions between human and hardware occur. The user interface can be a touch screen, a voice user interface, a gesture-based interface or the like. The wireless communication devices can be implemented in or part of various electronic devices: Examples of the electronic devices can include, but not limited to, consumer electronic products, electronic test equipment, and cellular communications infrastructure such as a base station. Examples of the electronic devices can include, but not limited to, a mobile phone such as a smart phone, a wearable computing device such as a smart watch or an ear piece, a telephone, a television, a computer monitor, a computer, a modem, a hand-held computer, a laptop computer, a table computer, a personal digital assistant, a microwave, a refrigerator, a vehicular electronic system such as an automotive electronics system, a stereo system, a DVD player, a CD player, a digital music player such as an MP3 player, a radio, a camcorder, a camera such as a digital camera, a portable memory chip, a washer, a dryer, a washer/dryer, peripheral devices, a clock, etc. Further, the electronic devices can include unfinished products.

Where appropriate, the above-mentioned configurations and developments can be combined with each other as desired, as far as this is reasonable. Further possible configurations, developments and implementations of the invention also include combinations, which are not explicitly mentioned, of features of the invention which have been described previously or are described in the following with reference to the configurations. In particular, in this case, a person skilled in the art will also assess individual aspects as improvements or supplements to the basic form of the present invention.

### BRIEF DESCRIPTION OF THE DRAWINGS

For a more comprehensive understanding of the invention and the advantages thereof, exemplary configurations of the invention are explained in more detail in the following description with reference to the accompanying drawing figures, in which like reference characters designate like parts and in which:

FIG. 1 illustrates a schematic diagram of an example of a communication network;

FIG. 2 illustrates a schematic diagram of another example of a communication network;

FIG. 3A illustrates a schematic diagram of an example of multiple downlink channels at UE side using MIMO antenna system;

FIG. 3B illustrates a schematic diagram of an example of multiple uplink channels at UE side using MIMO antenna system;

FIG. 4 illustrates a schematic block diagram of an RF front-end architecture according to an embodiment;

FIG. 5 illustrates a schematic block diagram of an RF module according to an embodiment;

FIG. 6 illustrates a schematic block diagram of a wireless communication device according to an embodiment; and

FIG. 7 illustrates a chronology diagram for the allocation of transmitted or received RF signals for different time slots.

The appended drawings are intended to provide further understanding of the configurations of the invention. They illustrate configurations and, in conjunction with the description, help to explain principles and concepts of the invention. Other configurations and many of the advantages mentioned become apparent in view of the drawings. The elements in the drawings are not necessarily shown to scale.

In the drawings, like functionally equivalent and identically operating elements, features and components are provided with like reference signs in each case, unless stated otherwise.

### DETAILED DESCRIPTION OF CERTAIN EMBODIMENTS

The International Telecommunication Union (ITU) is a specialized agency of the United Nation (UN) responsible for global issues concerning information and communication technologies, including the shared global use of radio spectrum.

The 3rd Generation Partnership Project (3GPP) is a collaboration between groups of telecommunications standard bodies across the world, such as the Association of Radio Industries and Businesses (ARIB), the Telecommunications Technology Committee (TTC), the China Communications Standards Association (CCSA), the Alliance for Telecommunications Industry Solutions (ATIS), the Telecommunications Technology Association (TTA), the European Telecommunications Standards Institute (ETSI), and the Telecommunications Standards Development Society of India (TSDSI).

Working within the scope of the ITU, 3GPP develops and maintains technical specifications for a variety of mobile communication technologies, including, for example, second generation (2G) technology, for instance, Global System for Mobile Communications (GSM), and Enhanced Data Rates for GSM Evolution (EDGE) third generation (3G) technology, for instance, Universal Mobile Telecommunications System (UMTS), and High Speed Packet Access (HSPA), and fourth generation (4G) technology, for instance, Long Term Evolution (LTE) and LTE-Advanced.

The technical specifications controlled by 3GPP can be expanded and revised by specification releases, which can span multiple years and specify a breadth of new features and evolutions.

In one example, 3GPP introduced carrier aggregation (CA) for LTE in Release 10. Although initially introduced with two downlink carriers, 3GPP expanded carrier aggregation in Release 14 to include up to five downlink carriers and up to three uplink carriers. Other examples of new features and evolutions provided by 3GPP releases include, but are not limited to, License Assisted Access (LAA), enhanced LAA (eLAA), Narrowband Internet of things (NB-IOT), Vehicle-to-Everything (V2X), and High Power User Equipment (HPUE).

3GPP introduced Phase 1 of fifth generation (5G) technology in Release 15, and introduced Phase 2 of 5G technology in Release 16. Subsequent 3GPP releases will further evolve and expand 5G technology. 5G technology is also referred to herein as 5G New Radio (5G NR).

5G NR supports or plans to support a variety of features, such as communications over millimeter wave spectrum, beamforming capability, high spectral efficiency waveforms, low latency communications, multiple radio numerology, and/or non-orthogonal multiple access (NOMA). Although such RF functionalities offer flexibility to networks and enhance user data rates, supporting such features can pose a number of technical challenges.

The teachings herein are applicable to a wide variety of communication systems, including, but not limited to, communication systems using advanced cellular technologies, such as LTE-Advanced, LTE-Advanced Pro, and/or 5G NR.

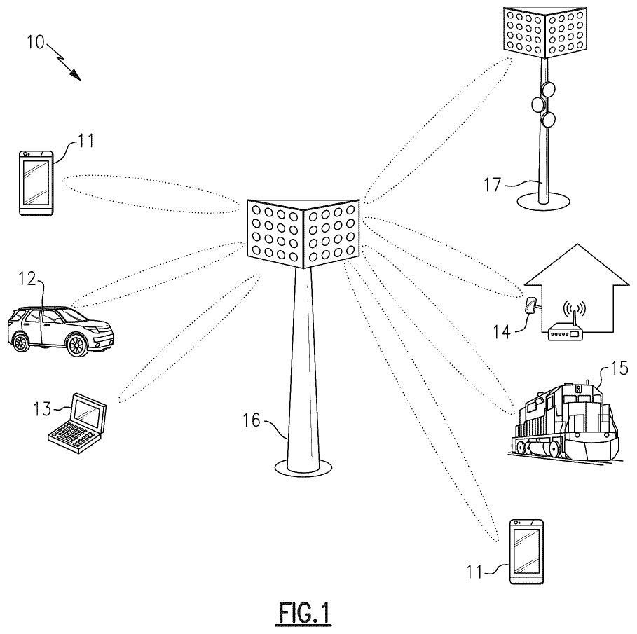

FIG. 1 illustrates a schematic diagram of an example of a communication network.

The communication network in FIG. 1 is denoted by reference number 10. The communication network 10 shown in FIG. 1 includes a macro cell base station 16, a small cell base station 17, and various examples of different UEs 11-15. The UEs 11-15 may include mobile devices 11, a wireless-connected car 12, a laptop 13, a stationary wireless device 14, and a wireless-connected train 15. Although specific examples of base stations and UEs are illustrated in FIG. 1, a communication network can include base stations and UEs of a wide variety of types and/or numbers. For instance, in the example show in FIG. 1, the communication network 10 includes the macro cell base station 16 and the small cell base station 17. The small cell base station 17 can operate with relatively lower power, shorter range, and/or with fewer concurrent users relative to the macro cell base station 16. The small cell base station 17 can also be referred to as a femtocell, a picocell, or a microcell. Although the communication network 10 is illustrated as including two base stations, the communication network 10 can be implemented to include more or fewer base stations and/or base stations of other types.

The communication network 10 of FIG. 1 can be used to support a wide variety of advanced communication features, including, but not limited to, enhanced mobile broadband (eMBB), ultra reliable and low latency communications (uRLLC), and/or massive machine type communication (mMTC).

eMBB refers to technology for growing system capacity of LTE networks. For example, eMBB can refer to communications with a peak data rate of at least 10 Gbps and a minimum of 100 Mbps for each user device. uRLLC refers to technology for communication with very low latency, for instance, less than 2 milliseconds. uRLLC can be used for mission-critical communications such as for autonomous driving and/or remote surgery applications. mMTC refers to low cost and low data rate communications associated with wireless connections to everyday objects, such as those associated with Internet of Things (IoT) applications.

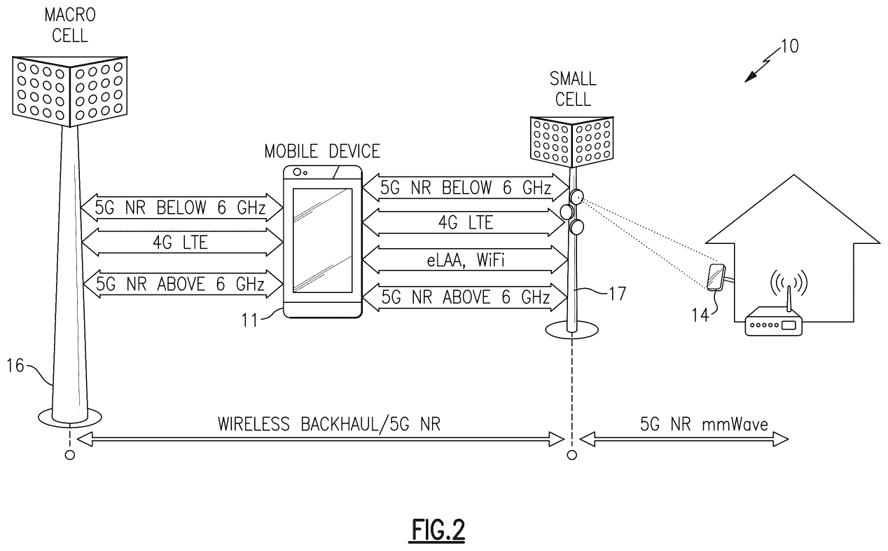

FIG. 2 is a schematic diagram of another example of a communication network 10. The communication network 10 includes a macro cell base station 16, a mobile device 11, a small cell base station 17, and a stationary wireless device 14.

The illustrated communication network 10 of FIG. 2 supports communications using a variety of technologies, including, for example, 4G LTE, 5G NR, and wireless local area network, WLAN, such as Wi-Fi. Although various examples of supported communication technologies are shown, the communication network 10 can be adapted to support a wide variety of communication technologies.

As shown in FIG. 2, the mobile device 11 communicates with the macro cell base station 16 over a communication link that uses a combination of 4G LTE and 5G NR technologies. The mobile device 11 also communications with the small cell base station 17. In the illustrated example, the mobile device 11 and small cell base station 17 communicate over a communication link that uses 5G NR, 4G LTE, and Wi-Fi technologies. In certain implementations, eLAA is used to aggregate one or more licensed frequency carriers, for instance, licensed 4G LTE and/or 5G NR frequencies, with one or more unlicensed carriers, for instance, unlicensed Wi-Fi frequencies.

In certain implementations, the mobile device 11 communicates with the macro cell base station 16 and the small cell base station 17 using 5G NR technology over one or more frequency bands that are less than 7.5 Gigahertz, GHz, and/or over one or more frequency bands that are greater than 7.5 GHz. For example, wireless communications can utilize Frequency Range 1 (FR1), Frequency Range 2 (FR2), or a combination thereof. In one embodiment, the mobile device 11 supports a high power user equipment (HPUE) power class specification.

The illustrated small cell base station 17 also communicates with a stationary wireless device 14. The small cell base station 17 can be used, for example, to provide broadband service using 5G NR technology. In certain implementations, the small cell base station 17 communicates with the stationary wireless device 14 over one or more millimeter wave frequency bands in the frequency range of 30 GHz to 300 GHz and/or upper centimeter wave frequency bands in the frequency range of 24 GHz to 30 GHz.

The communication network 10 of FIG. 2 includes the macro cell base station 16 and the small cell base station 17. In certain implementations, the small cell base station 17 can operate with relatively lower power, shorter range, and/or with fewer concurrent users relative to the macro cell base station 16. The small cell base station 17 can also be referred to as a femtocell, a picocell, or a microcell.

Although the communication network 10 is illustrated as including two base stations, the communication network 10 can be implemented to include more or fewer base stations and/or base stations of other types. As shown in FIG. 2, base stations can communicate with one another using wireless communications to provide a wireless backhaul. Additionally or alternatively, base stations can communicate with one another using wired and/or optical links.

The communication network 10 of FIG. 2 is illustrated as including one mobile device 11 and one stationary wireless device 14. The mobile device 11 and the stationary wireless device 14 illustrate two examples of UEs. Although the communication network 10 is illustrated as including two UEs, the communication network 10 can be used to communicate with more or fewer UEs and/or UEs of other types. For example, user devices can include mobile phones, tablets, laptops, IoT devices, wearable electronics, and/or a wide variety of other communications devices.

UEs of the communication network 10 can share available network resources, for instance, available frequency spectrum, in a wide variety of ways.

In one example, frequency division multiple access (FDMA) is used to divide a frequency band into multiple frequency carriers. Additionally, one or more carriers are allocated to a particular user. Examples of FDMA include, but are not limited to, single carrier FDMA (SC-FDMA), and orthogonal FDMA (OFDMA). OFDMA is a multicarrier technology that subdivides the available bandwidth into multiple mutually orthogonal narrowband subcarriers, which can be separately assigned to different users.

Other examples of shared access include, but are not limited to, time division multiple access (TDMA) in which a user is allocated particular time slots for using a frequency resource, code division multiple access (CDMA) in which a frequency resource is shared amongst different users by assigning each user device a unique code, space-divisional multiple access (SDMA) in which beamforming is used to provide shared access by spatial division, and non-orthogonal multiple access (NOMA) in which the power domain is used for multiple access. For example, NOMA can be used to serve multiple user devices at the same frequency, time, and/or code, but with different power levels.

The communication network 10 of FIG. 2 can be used to support a wide variety of advanced communication features, including, but not limited to eMBB, uRLLC, and/or mMTC.

A peak data rate of a communication link, for instance, between a base station and a user device, depends on a variety of factors. For example, peak data rate can be affected by channel bandwidth, modulation order, a number of component carriers, and/or a number of antennas used for communications.

For instance, in certain implementations, a data rate of a communication link can be about equal to M*B*log 2 (1+S/N), where M is the number of communication channels, B is the channel bandwidth, and S/N is SNR.

Accordingly, data rate of a communication link can be increased by increasing the number of communication channels, for instance, transmitting and receiving using multiple antennas, using wider bandwidth, for instance, by aggregating carriers, and/or improving SNR, for instance, by increasing transmit power and/or improving receiver sensitivity.

5G NR communication systems can employ a wide variety of techniques for enhancing data rate and/or communication performance.

Various communication links of the communication network 10 have been depicted in FIG. 2. The communication links can be duplexed in a wide variety of ways, including, for example, using half FDD and/or TDD. Half FDD is a type of radio frequency communications that uses different frequencies for transmitting and receiving signals. Half FDD scheme is similar with the FDD scheme separates the transmit and receive paths on different frequencies. However, unlike FDD allowing simultaneous bidirectional communication, half FDD scheme has the limitation that it does not allow bidirectional communication at the same timeslot. Half FDD can provide a number of advantages, for example, simplifying the implementation without the use of antennaplexer or other alternative components integrated with the function of antennaplexer, especially for multi-band terminals in situations with a narrow frequency separation between uplink and downlink. In contrast, TDD is a type of radio frequency communications that uses about the same frequency for transmitting and receiving signals, and in which transmit and receive communications are switched in time. TDD can provide a number of advantages, such as efficient use of spectrum and variable allocation of throughput between transmit and receive directions.

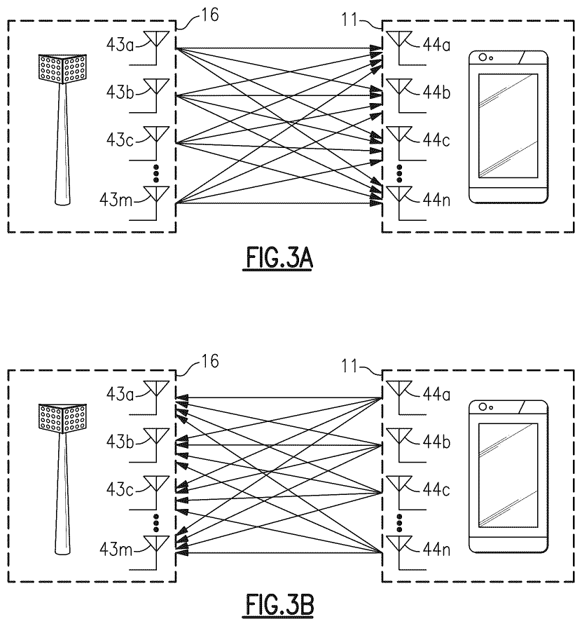

FIG. 3A is a schematic diagram of an example of a downlink channels at UE side using MIMO antenna system.

In the example show in FIG. 3A, downlink MIMO communications are provided by transmitting using M antenna 43a, 43b, 43e, . . . 43m at the base station 16 and receiving using N antennas 44a, 44b, 44c, . . . , 44n of the mobile device 11. Accordingly. FIG. 3A illustrates an example of MxN DL MIMO.

In certain implementations, the RF signals operate with different reference signals to enhance signal reception at the receiver. MIMO communications benefit from higher SNR, improved coding, and/or reduced signal interference due to spatial multiplexing differences of the radio environment.

MIMO order refers to a number of separate data streams sent or received. For instance, MIMO order for downlink communications can be described by a number of transmit antennas of a base station and a number of receive antennas for UE, such as a mobile device. For example, two-by-two, 2×2, DL MIMO refers to MIMO downlink communications using two base station antennas and two UE antennas. Additionally, four-by-four, 4×4, DL MIMO refers to MIMO downlink communications using four base station antennas and four UE antennas.

FIG. 3B is schematic diagram of an example of an uplink channels at UE side using MIMO antenna system.

In the example show in FIG. 3B, uplink MIMO communications are provided by transmitting using N antennas 44a, 44b, 44c, . . . 44n of the mobile device 11 and receiving using M antennas 43a, 43b, 43c, . . . 43m of the base station 16. Accordingly, FIG. 3B illustrates an example of N×M UL MIMO.

Likewise, MIMO order for uplink communications can be described by a number of transmit antenna of UE, such as a mobile device, and a number of receive antennas of a base station. For example, 2×2 UL MIMO refers to MIMO uplink communications using two UE antenna and two base station antennas. Additionally, 4×4 UL MIMO refers to MIMO uplink communications using four UE antennas and four base station antennas.

By increasing the level or order of MIMO, bandwidth of an uplink channel and/or a downlink channel can be increased.

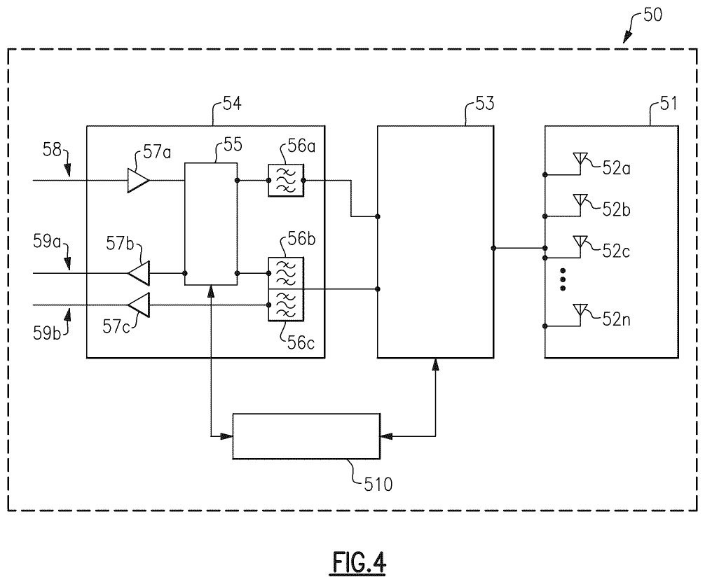

FIG. 4 illustrates a schematic block diagram of an RF front-end architecture 50 according to some embodiments.

In the illustrated configuration, the RF front-end architecture 50 includes an antenna component 51, a controllable second RF switch module 53 (also referred to herein as an “antenna switch”), a transmit/receive component 54 and a control device 510. The transmit/receive component 54 includes a transmit path 58 for transmitting RF signals, two receive paths 59a and 59b for receiving RF signals and a controllable first RF switch module 55 arranged between the transmit path 58 and the receive path 59a in the transmit/receive component 54. The receive path 59b is coupled directly to the controllable second RF switch 53 without coupling to the controllable first RF switch module 55. The antenna component 51 includes a plurality of antennas 52a, 52b, 52c, . . . 52n.

The controllable second RF switch module 53 is arranged between the antenna component 51 and the transmit/receive component 54. The controllable first RF switch module 54 and the controllable second RF switch module 53 are controlled by the control device 510. The first controllable RF switch module 55 is configured to switch between the transmit path 58 and the receive path 59a. The controllable second RF switch module 53 is configured to activate one antenna of a plurality of antennas at a time and one after another and switch between a transmit mode and a receive mode.

The transmit/receive component 54 in the time slot of the RF front-end architecture 50 can be, but is not limited to, a broadband transmit/receive component, a broadband receive component, a mid-to-high band, MHB, duplexing component, a ultra-high-band, UHB, duplexing component, or the like.

The transmit path 58 in the transmit/receive component 54 comprises a transmit filter 56a and a power amplifier 57a. The transmit filter 56a is configured to filter RF signals through the transmit path 58. The power amplifier 57a is configured to amplify RF signals with low-power through the transmit path 58.

The transmit filter 56a processes the RF signal before its transmission. During transmit signal processing, a series of operations, such as signal mixing, spectrum shaping and the like, are introduced. In this process, the entire transmission signal will introduce various unwanted harmonics or noise, increasing the adjacent channel interference and impairing the SNR. In addition, in systems where the same antenna is used for both transmission and reception, for example, in TDD systems, filtering is crucial to protect the sensitive receiver components from being overloaded or damaged by strong out-of-band signals from the transmit path. As illustrated in FIG. 4, the transmit filter 56a is a band-pass filter.

However, the transmit filter 56a can also be low-pass filters, high-pass filters, band-stop filters or the like. The transmit filter 56a may adopt different filter technologies, such as lumped-element LC filters technology, planar filters technology, coaxial filters technology, cavity filters technology, dielectric filters technology, electroacoustic filters or the like. The transmit filter 56a may be tunable, in order to adapt to filter the RF signals in different frequency band without incorporation of additional filter components. The transmit filter 56a facilitates the control of the bandwidth of the transmit RF signal, the reduction of interference with adjacent channels, and the protection of receiver components in shared antenna systems.

The power amplifier 57a is used with its output driving the antenna in the transmit mode. The degrading of transmit signal in UE side due to the propagation losses over distance, obstructions, atmospheric absorption and the like, will be compensated by signal amplification of the power amplifier 57a. In this way, the desired transmit signal is not drowned in background noise. Design goals of the power amplifier often include gain, power output, bandwidth, power efficiency, linearity, input and output impedance matching, and heat dissipation.

The receive path 59a or 59b in the transmit/receive component 54 comprises a receive filter 56b or 56c and a low-noise amplifier 57b or 57c. The receive filter 56b or 56c is configured to filter RF signals through the receive path 59a or 59b. The low-noise amplifier 57b or 57c is configured to amplify RF signals with low-power through the receive path 59a or 59b.

The receive filter 56b or 56c processes the incoming RF signal before it is further amplified and demodulated. The receive RF signals from antennas are usually weak signals encoded information onto RF carriers. Due to the propagation interference over distance, the receive RF signals may superimpose unwanted random signals on the desired signal, which is impairing its SNR. As illustrated in FIG. 4, the receive filter 56b or 56c is a band-pass filter.

However, the receive filter 56b or 56c can be low-pass filters, high-pass filters, band-stop filters, or the like. The receive filter 56b or 56c may adopt different filter technologies, such as lumped-element LC filters technology, planar filters technology, coaxial filters technology, cavity filters technology, dielectric filters technology, electroacoustic filters or the like. The receive filter 56b or 56c may be tunable, in order to adapt to filter the RF signals in different frequency band without incorporation of additional filter components. The receive filter 56b or 56c facilitates the selecting and isolating of the desired frequency bands, rejecting out-of-band and adjacent channel interference, and protecting sensitive receiver components from overload.

The low-noise amplifier 57b or 57c is configured to amplify RF signals with low-power without significantly degrading its signal-to-noise ratio, SNR, through the receive path 59a or 59b. The receive RF signals from antennas are usually weak signals due to the propagation losses over distance, obstructions, atmospheric absorption, antenna characteristics, interference, and power limitations of the transmitter. As a result, most of RF receive signals are just above the noise floor. Any electronic amplifier will amplify the power of both the signal and the noise present at its input. Additionally, the amplifier will also introduce some additional noise by itself. The low-noise amplifier 59a or 59b is designed to supply a power gain of the receive RF signals and minimize that additional noise at the same time. Design goals of the low-noise amplifier 59a or 59b often include gain, noise figure, linearity and maximum RF input.

When the proposed RF front-end architecture 50 is selected to operate in the transmit mode, the controllable second RF switch module 53 is configured to switch the RF front-end architecture 50 to the transmit mode and active one antenna of a plurality of antennas at a time which is ready to transmit RF signals. The controllable first RF switch module 54 is configured to switch to the transmit path 58.

When the proposed RF front-end architecture 50 is selected to operate in the receive mode, the controllable second RF switch module 53 is configured to switch the RF front-end architecture 50 to the receive mode and active one antenna of a plurality of antennas at a time which is ready to receive RF signals. The controllable first RF switch module 54 is configured to switch to the receive path 59a by the controllable first RF switch module 54 or the controllable first RF switch module 54 is inactive and the receive path 59b is selected by the controllable second RF switch module 53.

The antenna component 51 comprises a plurality of antennas 52a, 52b, 52c. 52n. A plurality of antennas 52a, 52b, 52c, . . . 52n can be one antenna array. The antenna array may be composed from either at least one one-dimensional, two-dimensional or three-dimensional array that contains a number of antenna components, which are connected or interconnected with each other. The antenna gain is increasing with the addition of other antenna components.

For example, the implementation of a MIMO system may be a 2×2 MIMO system, which means it comprises an array of 2×2 antenna components. The implemented architecture can be easily scaled to 4×4 system, which means it comprises an array of 4×4 antenna components. The 4×4 system may also be composed of four 2×2 MIMO systems. The 1×8 antenna component array can be integrated along the edge of a wireless communication device, enabling beamforming at various angles to deliver usable beams along the edges of devices. Three-dimensional antenna component arrays, such as a 4×2×4 configuration or a 4×4×4 antenna configuration, exhibit improved performances when employing joint beamforming techniques. This technique enables the simultaneous achievement of array gain, spatial diversity or multiplexing gain. While traditional beamforming typically requires simultaneous antenna operation, some advanced forms of beamforming can work with phased operation, for instance, with integration of phased array systems, which use a sequential phase-shifting technique to steer beams.

The proposed RF front-end architecture no longer contains antennaplexers or other alternative components integrated with the function of antennaplexer. This benefits the purposed RF front-end architecture with lower insertion loss and enhanced power efficiency. The RF front-end architecture can support a time-division-duplex (TDD) scheme. TDD schemes separate transmitted and received RF signals by the allocation of different time slots in the same frequency band. In other words, for the communication device operating in TDD scheme, it can only transmit at one time and only receive at another time. TDD schemes are more preferable when there are asymmetric traffic patterns between the downlink channels and the uplink channels, such that the cost of the RF front-end architecture is reduced and it requires less quantity of spectrum. Without the need for frequency separation, the RF front-end architecture is designed without antennaplexers. This can be lead to more easily adaptation for dynamic switching between transmit and receive modes.

Without antennaplexer or other alternative components integrated with the function of antennaplexer, the RF front-end architecture can also support a half frequency-division-duplex (FDD) scheme when it incorporates alternative components such as dual-band filters, dual-band amplifiers, dual-band antennas with filtering performance or the like. Half FDD schemes are similar to conventional FDD schemes that separate the transmit and receive paths on different frequencies. However, unlike FDD schemes allowing simultaneous bidirectional communication, half FDD schemes do not allow bidirectional communication in the same timeslot.

For the reason that the alternative components can operate with more than one frequency bands, these components can effectively separate the transmit and receive paths, thereby fulfilling the role of an antennaplexer. This allows the RF front-end architecture to handle bidirectional communication in different frequency bands.

In order to eliminate the duplication of hardware without compromising their spectral efficiency, SNR and achievable gain, a single transmit/receive component is coupled to the antenna component with a plurality of antennas and a controllable second RF switch module controlled by a control device is arranged between the antenna component and the transmit/receive component, the controllable second RF switch module actives one antenna of a plurality of antennas at a time and one after another. The transmission or the reception result is then aggregated over multiple transmission/reception time periods. This allows range extension and even potentially higher modulation coding scheme (MCS) index or higher order modulation, etc.

Different MIMO operation modes, such as transmit diversity, receive diversity, uplink MIMO, downlink MIMO and the like, is still achieved with the use of proposed RF front-end architecture, so that the high SNR and the achievable gain of the proposed RF front-end architecture are stilled realized. Furthermore, the hardware cost is also reduced by eliminating the antennaplexer and duplication of the hardware in RF front-end architecture.

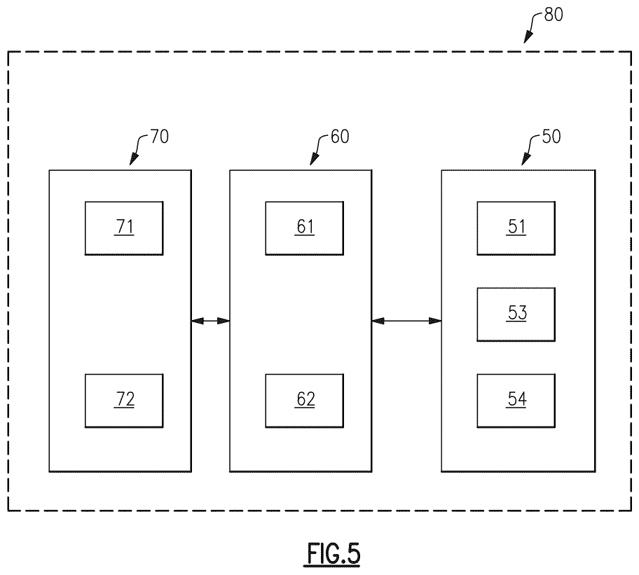

FIG. 5 illustrates a schematic block diagram of a RF module 80 according to an embodiment.

The illustrated configuration of RF module 80 includes a RF front-end architecture 50, a transceiver component 60 and a baseband processor component 70. The RF front-end architecture 50 has been described in FIG. 4. The transceiver component 60 includes modulator 61 and demodulator 62. The baseband processor component 70 includes DAC 71 and ADC 72.

The modulator 61 is configured to convert transmission analog signals into a format suitable for RF signals transmission. The demodulator 62 is configured to extract the reception analog signals from the received RF signals.

A modulator 61—demodulator 62 or modem is a computer hardware device that converts data from a digital format into a format suitable for an analog transmission medium such as telephone or radio. A modem transmits data by modulating one or more carrier wave signals to encode digital information, while the receiver demodulates the signal to recreate the original digital information. The goal is to produce a signal that can be transmitted easily and decoded reliably. The modulation or demolition technologies can be analog modulation including amplitude modulation, frequency modulation, phase modulation, space modulation and the like, or digital modulation including amplitude-shift keying, amplitude and phase-shift keying, continuous phase modulation, quadrature amplitude modulation and the like.

The DAC 71 is configured to convert transmission data steams into transmission analog signals. The ADC 72 is configured to convert reception analog signals into reception data streams. In the transmit mode of the RF module 80, DAC 71 converts digital signal processing outputs to analog signals before amplification and transmission. In a further possible configuration, DAC 71 is used to produce analog control signals for various purposes such as gain control, filter tuning, system verification, testing, or calibration purposes or phase adjustment in the analog domain. An ADC 72 operates at a high sampling rate and converts signals directly from RF to digital. In the receive mode of the RF module 80, the RF signal is first downconverted to an intermediate frequency, IF, or directly to baseband. An ADC 72 is then used to convert the analog IF or baseband signal into a digital signal for further processing. After the analog RF signal is converted to a digital signal, digital signal processing, DSP, techniques are used to demodulate the signal and extract the transmitted information.

Although in this illustration the DAC 71 and the ADC 72 have been included in the transceiver component 60, and the modulator 61 and the demodulator 62 have been included in the baseband processor unit 70, the same statement applies to other examples that do not explicitly separate the functionality of the transceiver component 60 and the baseband processor unit 70. For example, the transceiver component 60 may also integrate with modulation or demodulation functionality or the baseband processor unit 70 may also integrate with digital-to-analog conversion and analog-to-digital conversion functionality. It will be understood that various functionalities associated with the transmission and receiving of RF signals can be achieved by one or more components that are collectively represented in FIG. 5. In one example, separate components, for instance, separate circuits or dies, can be provided for handling certain types of RF signals.

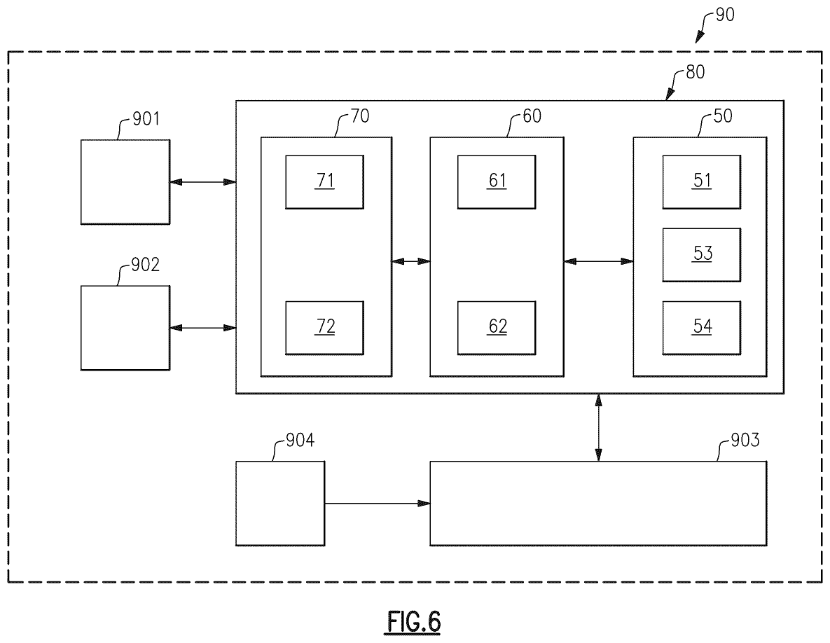

FIG. 6 illustrates a schematic block diagram of a wireless communication device 90 according to an embodiment.

The wireless communication device 90 includes a RF module 80, a user interface 901, a memory 902, battery 904 and power management 903.

The RF module 80 includes a RF front-end architecture 50, a transceiver component 60 and a baseband processor component 70. The RF front-end architecture 50 has been described in FIG. 4. The transceiver component 60 includes modulator 61 and demodulator 62. The baseband processor component 70 includes DAC 71 and ADC 72. The RF module 70 has been described in FIG. 5.

The wireless communication device 90 can be used communicate with a wide variety of communications technologies, including, but not limited to, 2G, 3G, 4G including LTE, LTE-Advanced, and LTE-Advanced Pro, 5G NR, WLAN (for instance WiFi), WPAN (for instance, Bluetooth and ZigBee), WMAN (for instance, WiMax), and/or GPS technologies.

The transceiver component 60 generates RF signals for transmission and processes incoming RF signals received from the RF front-end architecture 50. It will be understood that various functionalities associated with the transmission and receiving of RF signals can be achieved by one or more components that are collectively represented in FIG. 6. In one example, separate components, for instance, separate circuits or dies, can be provided for handling certain types of RF signals.

The RF front-end architecture 50 aids in conditioning signals transmitted to and/or received from the antenna component 51. The RF front-end architecture is described in FIG. 4. However, other implementations are possible.

For example, the RF front-end architecture 50 can provide a number of functionalities, including, but not limited to, amplifying signals for transmission, amplifying received signals, filtering signals, switching between different bands, switching between different power modes, switching between transmission a d receiving modes, duplexing of signals, and the like, or the same combination thereof.

The transceiver component 60 can provide a number of functionalities, including, but not limited to, frequency conversion, modulation and demodulation, signal mixing, digital signal processing, carrier sensing and channel access, and the like, or the same combination thereof.

The baseband processor unit 70 can provide a number of functionalities, including, but not limited to, channel coding and decoding, protocol handling, digital signal processing, security and encryption, and the like, or the same combination thereof.

The wireless communication device 90 may comprise at least one central processing unit, CPU, a memory, a battery, a power management unit, a motherboard and/or at least one user interface attached to or at least partially embedded in the housing of the wireless communication device. The user interface is the space where interactions between human and hardware occur. The user interface can be a touch screen, a voice user interface, a gesture-based interface or the like. The wireless communication devices can be implemented in or part of various electronic devices: Examples of the electronic devices can include, but not limited to, consumer electronic products, electronic test equipment, cellular communications infrastructure such as a base station, etc. Examples of the electronic devices can include, but not limited to, a mobile phone such as a smart phone, a wearable computing device such as a smart watch or an ear piece, a telephone, a television, a computer monitor, a computer, a modem, a hand-held computer, a laptop computer, a table computer, a personal digital assistant, a microwave, a refrigerator, a vehicular electronic system such as an automotive electronics system, a stereo system, a DVD player, a CD player, a digital music player such as an MP3 player, a radio, a camcorder, a camera such as a digital camera, a portable memory chip, a washer, a dryer, a washer/dryer, peripheral devices, a clock, etc. Further, the electronic devices can include unfinished products.

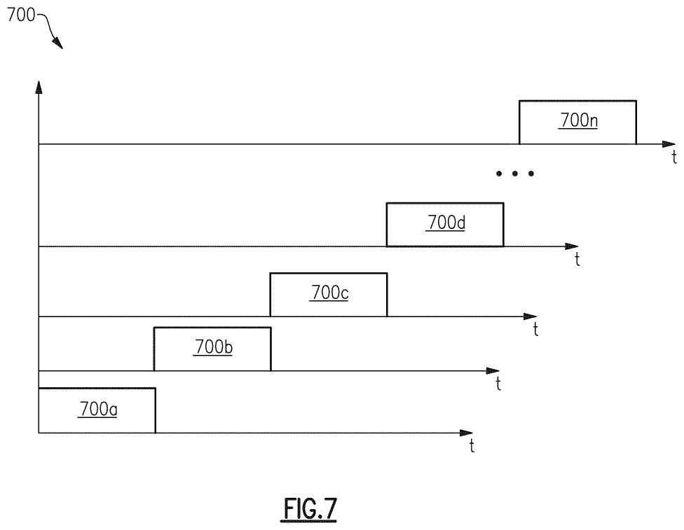

FIG. 7 illustrates a chronology diagram 700 for the allocation of transmitted or received RF for different time slots. Each time slot 700a, 700b, 700c, 700d, . . . 700n is carrying information related to the transmission or reception frame and allocated with series sequence without overlapping, such that the time slots are time-staggered. A whole result of transmission or reception data streams from RF signals is aggregated over multiple series transmission or reception time periods.

This allows range extension and even potentially higher modulation coding scheme (MCS) index or higher order modulation, etc. higher order modulation is a type of digital modulation usually with an order of 4 or higher, such as QPSK, and m-QAM. QPSK is also known as quadriphase PSK, 4-PSK, or 4-QAM. QPSK uses four points on the constellation diagram, equispaced around a circle. With four phases, QPSK can encode two bits per symbol. m-QAM can be 16-QAM, 32-QAM, 64-QAM or higher with the powers of two. By moving to a higher-order constellation, it is possible to transmit more bits per symbol. 16-QAM can encode four bits per symbol, 32-QAM can encode five bits per symbol and 64-QAM can encode eight bits per symbol.

The final transmit signal will be aggregated over multiple series transmission time periods. Similarly, the final receive signal will be aggregated over multiple series reception time periods. All the time periods carrying transmit or receive information may be called frames. Each frame carrying transmit or receive data symbols may be called subframe. Each transmit subframe contains only transmit symbols and each receive subframe contains only receive symbols. The interval that separates neighboring symbols is called cyclic prefixes. By separating the neighboring symbols flexibly in the series subframes, each symbol can contain more bits. Therefore, it is possible to move to a higher-order modulation by transmitting or receiving RF signals in series operation.

Some of the configurations described above have provided examples in connection with RF components, front end modules and/or wireless communications devices. However, the principles and advantages of the configurations can be used for any other systems or apparats that could benefit from any of the circuits described herein. Although described in the context of RF circuits, one or more features described herein can also be utilized in packaging applications involving non-RF components. Similarly, one or more features described herein can also be utilized in packaging applications without the electromagnetic isolation functionality. Any of the principles and advantages of the configurations discussed can be used in any other systems or apparatus that could benefit from the antenna and/or the shielding structures discussed herein.

The following is an explanation of the technical terms that relate to this application:

The term “RF front-end” has several different variations of definitions from narrow to wide meaning. According to one reference, the RF front-end is generally defined as everything between the antenna and the digital baseband system. For a receiver, this “between” area includes all the filters, LNAs, and down-conversion mixer(s) needed to process the modulated signals received at the antenna into signals suitable for input into the baseband, ADC. According to another reference, The RF front-end is made up of a number of key components: the antenna(s) and antenna tuner(s), duplexers, filters, diplexers, and switches used for frequency control, transmitters and RF power amplifiers, receivers and LNAs. The baseband and RF (mixers, down converter, etc.) section, a key component in the overall UE, is not part of the RF front-end. Both definition can be correct depending on the context. In this application, most of the detailed description would be around the section in the latter definition.

Spectral efficiency can be represented by spectrum efficiency or bandwidth efficiency, where it refers to the amount of the information that can be transmitted over a given bandwidth in a specific communication system. SNR is a measure in RF communication systems that compares the level of a desired signal to the level of background noise, which is defined as the ratio of signal power to noise power. Achievable gain refers to the amount of the amplification that the system can provide to the transmitted signals or the received signals, the achievable gain further relates to the amplifier performance, the operating frequency band, the impendence matching, the design architecture or the like of the RF front-end architecture.

MIMO systems are RF communication systems having multiple antennas in both the transmitter and the receiver. The MIMO system in modern communication systems presents several operating modes, such as transmit diversity, receive diversity, spatial diversity, spatial multiplexing, cyclic delay diversity, beamforming and the like. The number of layers of MIMO system refers to the number of independent data streams being transmitted or being received.

In the transmit diversity mode of MIMO system, the transmitter will send copies of the same RF signals by each antenna, which will result in introduction of redundancy on the communication system. In the receive diversity mode of MIMO system in communication systems, the receiver will receive copies of the same RF signals by each antenna, which will result in introduction of redundancy on the communication system.

Spatial diversity is a technique in MIMO system that reduces signal fading by sending multiple copies of the same radio signal through multiple antennas; spatial multiplexing is a technique in MIMO that boosts data rates by sending the data payload in separate streams through spatially separated antennas.

In the cyclic delay diversity mode of MIMO system, it is the increase of a delay in each signal by adding antenna specific cyclic shifts. That results in an additional multipath behavior increasing frequency diversity what will reduced intersymbol interference and improve SNR.

In the beamforming mode of MIMO system, an antenna array with closely spaced elements is used to focus the energy in the direction of the terminal. This is achieved by adapting the amplitude and gain of each antenna element to form the beam.

Unless the context clearly requires otherwise, throughout the description and the claims, the words “comprise,” “comprising,” “include,” “including” and the like are to be constructed in an inclusive sense, as opposed to an exclusive or exhaustive sense; that is to say, in the sense of “including, but not limited to.” The word “arranged”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, fall refer to this application as a whole and not to any particular portions of this application. Where the context permits, words in the above detailed description of certain configurations using the singular or plural number may also include the plural or singular number, respectively. The word “or” in reference to a list of two or more items, hat word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain configurations include, while other configurations do not include, certain features, elements and/or states. Thus, such conditional language is not generally intended to imply that features, elements and/or states are in any way required for one or more configurations or whether these features, elements and/or states are included or are to be performed in any particular configuration.

While certain configurations have been described, these configurations have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative configurations may perform similar functionalities with different components and/or circuit topologies, and same blocks may be deleted, moved, added, subdivided, combined, and/or modified. Each of these blocks may be implemented in a variety of different ways.

Any suitable combination of the elements and acts of the various configurations described above can be combined to provide further configurations. The accompanying claims and their equivalents are intended to cover such forms or modifications as would fall within the scope and spirit of the disclosure.

What is claimed is:

1. A radio frequency front-end system, comprising:
a plurality of antennas;
a transmit/receive component including a transmit path for transmitting radio frequency signals, a receive path for receiving radio frequency signals;
an antenna switch arranged between the plurality of antennas and the transmit/receive component; and
a control device configurable in a time-staggered diversity receive mode to control the antenna switch to connect a different one of the plurality of antennas to the receive path in each of a series of sequential time slots that do not overlap in time, such that the transmit/receive component redundantly receives the same data in each of the series of sequential time slots using a different one of the plurality of antennas.

2. The radio frequency front-end system of claim 1 wherein control device is further configurable in a time-staggered diversity transmit mode to control the antenna switch to connect a different one of the plurality of antennas to the transmit path in each of a series of sequential time slots that do not overlap in time, such that the transmit/receive component redundantly transmits the same data in each of the series of sequential time slots using a different one of the plurality of antennas.

3. The radio frequency front-end system of claim 2 wherein the transmit/receive component includes a switch, and the control device is configurable in the time-staggered diversity receive mode to control the switch to connect the receive path to the antenna switch.

4. The radio frequency front-end system of claim 3 wherein the control device is configurable in the time-staggered diversity transmit mode to control the switch to connect the transmit path to the antenna switch.

5. The radio frequency front-end system of claim 4 wherein the transmit/receive component further includes a second receive path connected directly to the antenna switch.

6. The radio frequency front-end system of claim 1 wherein the transmit path in the transmit/receive component includes at least one first filter.

7. The radio frequency front-end system of claim 3 wherein the transmit path includes a power amplifier and the receive path includes a low noise amplifier, the switch arranged between the power amplifier and the antenna switch and the switch arranged between the low noise amplifier and the antenna switch.

8. The radio frequency front-end system of claim 1 wherein the plurality of antennas are included in at least one antenna array.

9. The radio frequency front-end system of claim 8 wherein the antenna array is a MIMO antenna system supporting at least one of a downlink MIMO function and an uplink MIMO function.

10. The radio frequency front-end system of claim 1 wherein the radio frequency front-end system is configured to operate with a WiFi network protocol.

11. The radio frequency front-end system of claim 1 wherein the radio frequency front-end system is configured to operate with at least one global navigation satellite system (GNSS).

12. The radio frequency front-end system of claim 1 wherein the radio frequency front-end system is configured to operate with the Bluetooth technology standard.

13. A radio frequency module, comprising:
a printed circuit board;
a radio frequency front-end system arranged on the printed circuit board and including a plurality of antennas; a transmit/receive component including a transmit path for transmitting radio frequency signals, a receive path for receiving radio frequency signals; an antenna switch arranged between the plurality of antennas and the transmit/receive component; and a control device configurable in a time-staggered diversity receive mode to control the antenna switch to connect a different one of the plurality of antennas to the receive path in each of a series of sequential time slots that do not overlap in time, such that the transmit/receive component redundantly receives the same data in each of the series of sequential time slots using a different one of the plurality of antennas.

14. The radio frequency module of claim 13 wherein control device is further configurable in a time-staggered diversity transmit mode to control the antenna switch to connect a different one of the plurality of antennas to the transmit path in each of a series of sequential time slots that do not overlap in time, such that the transmit/receive component redundantly transmits the same data in each of the series of sequential time slots using a different one of the plurality of antennas.

15. The radio frequency module of claim 14 wherein the transmit/receive component includes a switch, and the control device is configurable in the time-staggered diversity receive mode to control the switch to connect the receive path to the antenna switch.

16. The radio frequency module of claim 15 wherein the control device is configurable in the time-staggered diversity transmit mode to control the switch to connect the transmit path to the antenna switch.

17. The radio frequency module of claim 16 wherein the transmit/receive component further includes a second receive path connected directly to the antenna switch.

18. A wireless communication device, comprising:
a housing;
at least one processing component arranged in the housing and configured to process information within the wireless communication device; and
a radio frequency module arranged in the housing, the radio frequency module including a printed circuit board and a radio frequency front-end arranged on the printed circuit board, the radio frequency front-end including a plurality of antennas; a transmit/receive component including a transmit path for transmitting radio frequency signals, a receive path for receiving radio frequency signals; an antenna switch arranged between the plurality of antennas and the transmit/receive component; and a control device configurable in a time-staggered diversity receive mode to control the antenna switch to connect a different one of the plurality of antennas to the receive path in each of a series of sequential time slots that do not overlap in time, such that the transmit/receive component redundantly receives the same data in each of the series of sequential time slots using a different one of the plurality of antennas.

19. The wireless communication device of claim 18 wherein control device is further configurable in a time-staggered diversity transmit mode to control the antenna switch to connect a different one of the plurality of antennas to the transmit path in each of a series of sequential time slots that do not overlap in time, such that the transmit/receive component redundantly transmits the same data in each of the series of sequential time slots using a different one of the plurality of antennas.

20. The wireless communication device of claim 19 wherein the transmit/receive component includes a switch, and the control device is configurable in the time-staggered diversity receive mode to control the switch to connect the receive path to the antenna switch.
